(19) United States
(12) Patent Application Publication
(10) Pub. No.: US 2009/0222198 A1
(43) Pub. Date: Sep. 3, 2009

(54) Method of determining a route as a function of the sinuosity index

(76) Inventor: Michel Raynaud, Fontenay-Sous-Bois (FR)

Correspondence Address: BUCHANAN, INGERSOLL & ROONEY PC, POST OFFICE BOX 1404, ALEXANDRIA, VA, 22313-1404, US

(21) Appl. No.: 11/665,654

(22) PCT Filed: Oct. 13, 2005
(86) PCT No.: PCT/EP05/11009

§ 371 Date: Apr. 10, 2009

(30) Foreign Application Priority Data
Oct. 18, 2004 (FR) 04/11026

(51) Int. Cl. G01C 21/36

(52) U.S. Cl. 701/200

(57) ABSTRACT

The invention relates to a method of determining routes between a point of departure (α) and a point of arrival (β) for a digital road mapping system comprising a set of segments that are representative of a road network. The inventive method comprises the following steps consisting in: receiving a route request containing the points of departure and arrival and the selected, preferred sinuosity level; identifying a plurality of potential routes; assigning a value to each of the potential routes as a function of the global sinuosity index thereof, which is established from the sinuosity index of each of the segments forming the potential routes; and selecting the potential route with the sinuosity index that best corresponds to the sinuosity level of the request.

The present invention relates to a method of determining routes between a point of departure (a) and a point of arrival (β) for a digital road mapping system comprising a set of segments and/or nodes, in which the established route takes into account the sinuosity level indicated by the user at the time of his request.

Many ways are known of calculating routes to establish the most advantageous way, for a user of the road system, to travel from a given point of departure to a given point of arrival. Today, various criteria enable different types of users to choose their route by preferring certain criteria, and/or by penalizing certain other criteria. For example, a journey can be made via a route giving preference to travel by freeways, or one minimizing fuel consumption, etc. However, no criterion relating to the sinuosity of a road or a portion of road is taken into consideration at the moment. Yet the latter point may be a determining factor in the choice of one route over another. For example, the prolonged use of a sinuous road may cause greater fatigue than on a straighter road. Some elderly and/or sick drivers or passengers may suffer from travel sickness and be subject to symptoms such as nausea, dizzy spells or blackouts, etc.

In the past, the cartographer, using a paper map, showed information relating to the sinuosity of certain roads or segments of road. Thus, certain databases used for modeling road networks still include such information. However, since such information has been obtained from a paper map, it is not very accurate due to the generalized representation on the map and it is subjective. In addition, keeping such data up to date is very tedious and costly, due to changes in the road network.

Furthermore, current data sources, for the most part on a large scale (i.e. a scale including a very high level of detail), do not include such information. Taking into account the enormous scope that this would represent, given the number of objects in current road databases, it is inconceivable to make manual entries (or update) to these databases in order to provide them with the data relating to sinuosity.

Evaluating the sinuosity index involves being able to take into account all the details of the course of all the segments. This is because simplifying the representation of some bends, loops or other curves in small-scale models (i.e. a scale including a low level of detail), produces often major errors for evaluating sinuosity and therefore the journey time arising therefrom. Thus, neither manual techniques, nor conventional digital techniques currently enable the precise evaluation of the sinuosity index of given segments or journeys, in particular very sinuous and long journeys, where the actual speed of the vehicle may vary considerably with respect to that calculated.

To remedy these various drawbacks, the invention provides a method of determining routes between a point of departure (a) and a point of arrival (β) for a digital road mapping system consisting of digital modeling elements of a road network comprising a set of segments representative of said road network and data relating to sinuosity for at least a portion of these segments, and including the following steps:
a route request is received including:
   the points of departure and arrival;
   the selected preferred sinuosity level;
a plurality of routes is identified;
each of said potential routes is assigned a rating as a function of its global sinuosity index established from the sinuosity index of each of the segments forming said potential routes;
the potential route whose sinuosity index best matches the sinuosity level of the request is selected.

Such a method can be used to classify or categorize the roads or portions of roads likely to be followed by a user, in order to enable him to consider this aspect in his choice of road or route. According to the situation, the time at his disposal, his physical shape, etc., a user may therefore choose a more or less sinuous route.

In some cases, for example during journeys with young children on board, or for more sensitive users or those in less good health, less sinuous routes will be preferred, even sometimes to the detriment of the journey time, it is thus possible to avoid the drawbacks or symptoms associated with travel sickness.

In other cases, users will wish to favor a route passing, for example, along a sinuous road, since such a road sometimes corresponds to an undulating and often picturesque, or even stunning landscape, as for example the gorges of the Tarn. For driving enthusiasts, a more sinuous route often means a drive that may be more varied and therefore more pleasant.

According to an advantageous embodiment of the invention, the type of sinuosity indicates a preference for the potential route having a substantially higher or substantially lower sinuosity.

According to another advantageous embodiment of the invention, the type of sinuosity indicates a preference for the potential route having substantially the highest or substantially the lowest sinuosity, or an intermediate sinuosity. The possible selection of the lowest sinuosity level for some routes involves considerable detours. In such cases, a compromise may be established between the sinuosity level and the total distance to be traveled.

Advantageously, said rating corresponds to the average sinuosity index of the route, evaluated thanks to the following relationship: Sis(ISsegment X Lsegment/Ltotal, in which ISsegment corresponds to the sinuosity index of a given segment, Lsegment corresponds to its length, and Ltotal corresponds to the total length of the route.

Preferably, the step of identifying the plurality of potential routes further includes the following steps:
a) segments are scanned adjacent to the node (or point) of departure or to the node chosen so as to determine the cost of each of the nodes to which these segments lead;
b) from these nodes is selected the one whose cost is most favorable according to the set criteria (the shortest, the fastest, the most economic, preferring freeways, etc. or a combination of these criteria);
c) step “a” is repeated and said scanning is continued until the node whose cost is most favorable matches the point of arrival.

Nodes can be either nodes corresponding to actual points or data of the modeling elements, or virtual nodes corresponding to segment intersections.

During this scanning phase, the multiplicity of assessed nodes means that a multiplicity of alternative routes are evaluated or considered. At the end of the process, one or more routes capable of meeting the request criteria are selected.

Advantageously, node scanning is carried out using Dijkstra's algorithm. According to another advantageous embodiment, scanning the nodes is carried out using FORD's algorithm.

The preferred route is that for which the sum of the ratings or costs between the point of departure and the point of arrival is optimal. Obviously establishing the rating or global cost can be done taking into account a number of more or less important parameters according to circumstances. For example, the sinuosity index can be considered on its own, or with other parameters such as the distance traveled, tolls, journey time, saving in gas, etc. Each of these different parameters may take on a more or less decisive importance, by associating more or less important weightings with each one, according to circumstances, e.g. as a function of one or more of the user's wishes.

The invention also provides software comprising code elements programmed for implementing the previously disclosed method, when said software is loaded into a computer system and executed by said computer system.

This software may be in the form of a product recorded onto a machine-readable medium, comprising programmed code elements as disclosed above.

The invention further provides a device for determining routes between a point of departure (a) and a point of arrival (β) for a digital road mapping system consisting of digital modeling elements of a road network comprising a set of segments representative of said road network and data relating to sinuosity for at least a portion of these segments, including:
a data input unit for receiving the data associated with a point of departure a, a point of arrival β and a desired sinuosity level for the route to be established;
access to a storage unit comprising a set of road network modeling elements;
a calculation unit designed for identifying a plurality of routes enabling each to connect points of departure and arrival taking into account the sinuosity index of the segments of each of the routes.

Advantageously, the sinuosity index is used to give differing weight to journeys having a high sinuosity index compared to journeys having a low sinuosity index.

Thus, with the aid of this device, it is possible to cause less sinuous journeys (with a low sinuosity index) to be preferred over more sinuous journeys (whose sinuosity index is higher).

Similarly, according to another embodiment, it is possible to cause more sinuous journeys (with a high sinuosity index) to be preferred over less sinuous journeys (whose sinuosity index is lower).

According to an advantageous embodiment, the device includes a guidance unit, designed to generate guidance information as a function of the mapping elements of the selected route.

Finally, the invention provides a computer system comprising a device as previously disclosed.

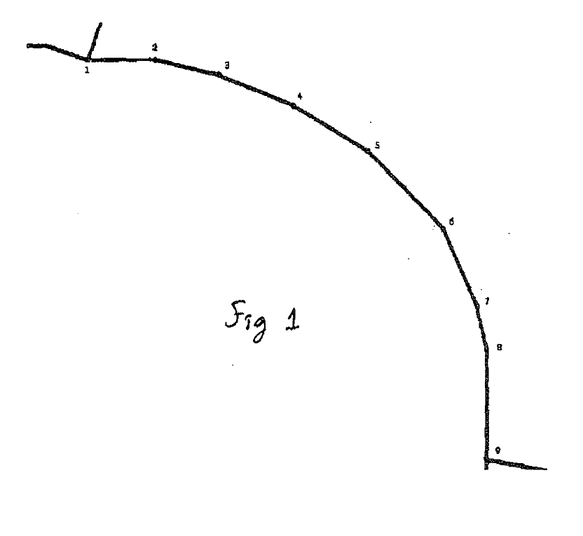

All the details of embodiment are given in the description that follows, completed by FIGS. 1 to 3 in which:

FIG. 1 shows an example of segments on which the intermediate points (from 1 to 9) are indicated;

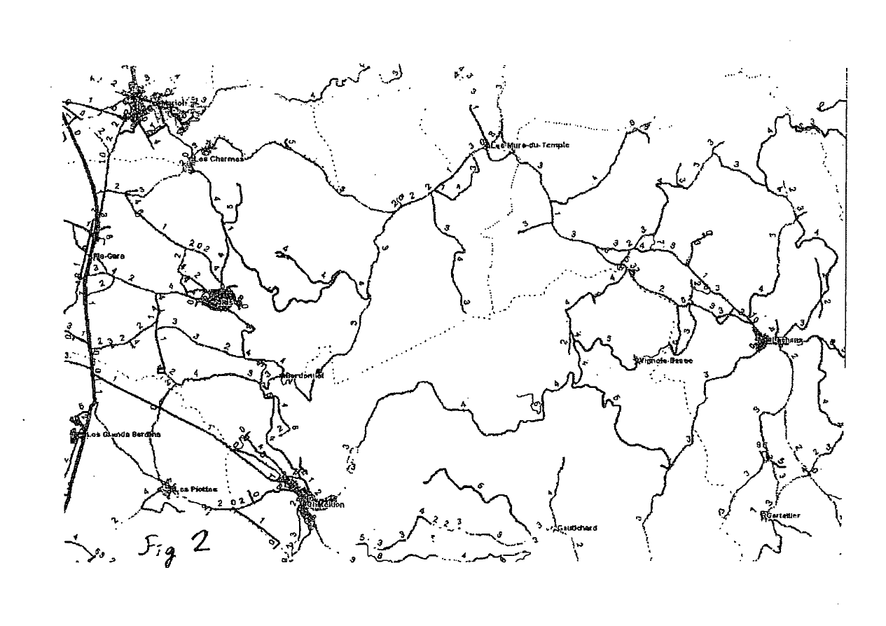

FIG. 2 depicts a representation of a portion of a road network in the region of Lachaux, with its corresponding sinuosity index opposite each segment of the database;

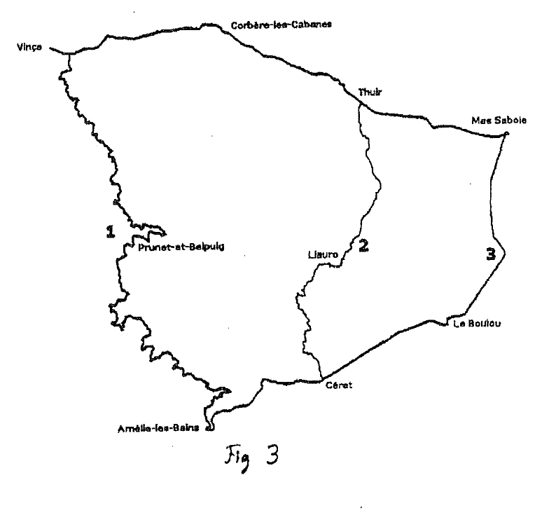

FIG. 3 shows a representation of a portion of a road network with three possibilities of routes between Vinça and Amélie-les-Bains, having three sinuosity indices that differ significantly.

In the present description, the following terms are used in particular with the following meanings:

“Node” refers to a point of intersection between a first mapping or road network (or other network) element and a second element of such a network, in particular the intersection between a plurality of roadways. A node also refers to a point of physical or qualitative change in a segment, as for example passing from two to three lanes, a change in speed limit, an area of roadwork (even temporary), a break point such as a border, etc.

“Segment” refers to a portion of road between two nodes.

“Intersection” refers to an intersection of several roads at the same level.

A “route” refers to a subset of points stemming from the modeling elements of road network, creating a link between the data enabling them to model or represent a journey or path on said road network used to connect a point of departure and a point of arrival. This subset is composed of data relating to the segments used to connect the departure and arrival. Data relating to the segments is understood to mean the identifications, lengths and spatial coordinates of the segments.

This subset can be used to represent said route in different forms, e.g. by means of a graphical representation, preferably in the form of a map including the point of departure, the point of arrival and the segments forming said route, or in the form of a “route sheet” or list of instructions, comprising a listing or series of instructions either written or represented by pictograms, explaining to a possible driver of a vehicle, the different steps to follow for taking said route.

According to the preferred embodiment, the density of intermediate points are calculated per 100 m of each segment measuring more than 50 m and having more than 5 intermediate points. Subsequently, as a function of this density, penalty factors are applied affecting the journey time (and obviously the speed) of the various segments. FIG. 1 shows an example of a segment on which the intermediate points (from 1 to 9 in this example) are represented. An intermediate point can be used to represent a change in direction between two segments or between two portions of the same segment. Thus, a segment representing a straight road has few intermediate points, whilst a segment representing a sinuous road has a plurality of intermediate points.

According to the preferred embodiment, penalty levels are subsequently applied as follows:

if d<3, no impact is applied to the duration of the segment;
if 3<=d<5, the duration of the segment is increased by 10% (10% reduction in speed);
if d>=5, the duration of the segment is increased by 20% (20% reduction in speed).

The table below presents an example of data obtained using the method according to the invention. This table includes the various segments for connecting Chateldon with Vignolle-Basse. The table includes the identifiers of each of the segments, their lengths, the calculated sinuosity indices, the standard journey times (without taking sinuosity into account), and the time or duration of journey obtained by taking sinuosity into account. This example shows well that the journey times of the segments with a high sinuosity index are liable to be heavily corrected using the method according to the invention.

| | | Length | Sinuosity | | Original | Final |
|---|---|---|---|---|---|---|
| Chateldon | Segment ID | (meters) | index | index*length | duration | duration |
| | 517640122 | 42 | 2 | 84 | 70 | 70 |
| | 517640127 | 34 | 6 | 204 | 53 | 64 |
| | 517691733 | 104 | 5 | 520 | 157 | 188 |
| | 517643257 | 52 | 4 | 208 | 79 | 87 |
| | 517694716 | 30 | 0 | 0 | 45 | 45 |
| | 517643250 | 129 | 3 | 387 | 194 | 213 |
| | 517599346 | 64 | 0 | 0 | 64 | 64 |
| | 517688011 | 786 | 3 | 2358 | 786 | 865 |
| | 517641069 | 3397 | 4 | 13588 | 3397 | 3737 |
| | 517662762 | 593 | 4 | 2372 | 593 | 652 |
| | 517655149 | 1221 | 5 | 6105 | 1221 | 1465 |
| Vignole- | | 6452 | Average | 25826 | 6659 | 7450 |
| Basse | | | index | | | |
| | | 6.4 km | 4.0 | | 6 m 40 s | 7 m 27 s |
| | | | | Average | 58 | 52 |
| | | | | speed: | | |

The journey presented in the table is further illustrated in FIG. 2. This figure illustrates an example of modeling elements shown in the form of a map, for a given sector, namely the area around Lachaux. The sinuosity indices of the segments, obtained by means of the method according to the invention, are shown on the map. It should be noted that there are numerous segments with a high index. The possibility of being able to take into account the impact of this sinuosity upon routes is therefore especially important for sectors such as that illustrated in this example.

Finally, the following table (below) and FIG. 3 present an example of using sinuosity data to perform very accurate route and journey time calculations. Three different routes have been set up, each connecting Amélie-les-Bains with Vinça. According to a user's precise request, it is possible to provide the best matching route, namely with a higher or lower sinuosity index, or even an intermediate index. Alternatively, several routes with different sinuosity indices may be suggested. The user has the possibility of adopting the one of his choice. FIG. 3 well illustrates the impact that sinuosity can have on a route between two given points.

Route from Amélie-les-Bains to Vinça

| | Distance | Time | Sinuosity |
|---|---|---|---|
| Rte No | km | minutes | index |
| Variant 1 (Prunet) | 43.6 | 51 | 4.57 |
| Variant 2 (Llauro) | 46.2 | 52 | 3.14 |
| Variant 3 (Le Boulou) | 53.2 | 53 | 1.99 |

The method according to the invention enables users to take into account the type of situation for producing accurate routes and accurately calculating journey time.

In general, routes are established by identifying a plurality of routes. This is done by selecting a first modeling element of the road network, preferably a node, close to the point of departure (a) and a second modeling element of the road network, preferably a node, close to the point of arrival (β), identifying a plurality of routes, each consisting of a plurality of modeling elements connected from the first element to the second element, and searching for at least one intermediate element for each of said routes in said set of road network modeling elements.

An algorithm of a known type is used for example, such as that of Dijkstra or Ford, in order to identify the routes capable of fulfilling the criteria of the request.

1. A method of determining routes between a point of departure (a) and a point of arrival (β) for a digital road mapping system consisting of digital modeling elements of a road network comprising a set of segments representative of said road network and data relating to sinuosity for at least a portion of these segments, and including the following steps:
a route request is received including:
the points of departure and arrival;
the selected preferred sinuosity level;
a plurality of potential routes is identified;
each of said potential routes is assigned a rating as a function of its global sinuosity index established from the sinuosity index of each of the segments forming said potential routes;
the potential route whose sinuosity index best matches the sinuosity level of the request is selected.

2. A method of determining routes as claimed in claim 1, characterized in that the sinuosity level indicates a preference for the potential route having a substantially higher or substantially lower sinuosity.

3. A method of determining routes as claimed in claim 1, characterized in that the sinuosity level indicates a preference for the potential route having a substantially higher, a substantially lower, or an intermediate sinuosity.

4. A method of determining routes as claimed in claim 1, characterized in that said rating corresponds to the average sinuosity index of the route, evaluated thanks to the following relationship: Sis(ISsegment X Lsegment/Ltotal, in which IS segment corresponds to the sinuosity index of a given segment, Lsegment corresponds to its length, and Ltotal corresponds to the total length of the route.

5. A method of determining routes as claimed in claim 1, characterized in that the step of identifying the plurality of potential routes further includes the following steps:
a) segments are scanned adjacent to the node (or point) of departure or to the node chosen so as to determine the cost of each of the nodes to which these segments lead;
b) from these nodes is selected the one whose cost is most favorable according to the set criteria; (the shortest, the fastest, the most economic, preferring freeways, etc. or any combination of these criteria);
c) step “a” is repeated and said scanning is continued until the node whose cost is most favorable matches the point of arrival.

6. A method of determining routes as claimed in claim 5, characterized in that scanning the nodes is carried out using Dijkstra's algorithm.

7. A method of determining routes as claimed in claim 5, characterized in that scanning the nodes is carried out using FORD's algorithm.

8. Software comprising code elements programmed for implementing the method as claimed in claim 1 when said software is loaded into a computer system and executed by said computer system.

9. Software in the form of a product recorded onto a machine-readable medium, comprising programmed code elements as claimed in claim 8.

10. A device for determining routes between a point of departure (a) and a point of arrival (β) for a digital road mapping system consisting of digital modeling elements of a road network comprising a set of segments representative of said road network and data relating to sinuosity for at least a portion of these segments, and including the following steps:
a data input unit for receiving the data associated with a point of departure a, a point of arrival β and a desired sinuosity level for the route to be established;
access to a storage unit comprising a set of road network modeling elements;
a calculation unit designed for identifying a plurality of routes enabling each to connect points of departure and arrival taking into account the sinuosity index of the segments of each of the routes.

11. A route calculation device as claimed in claim 10, characterized in that the sinuosity index is used to give differing weight to journeys having a high sinuosity index compared to journeys having a low sinuosity index.

12. A route calculation device as claimed in claim 10, including a guidance unit, designed to generate guidance information as a function of the mapping elements of the selected route.
